(19) United States
(12) Patent Application Publication
(10) Pub. No.: US 2014/0249838 A1
(43) Pub. Date: Sep. 4, 2014

(54) MEDICAL IMPLANT MANAGEMENT

(71) Applicant: David A. Gelb, West Hartford, CT (US)

(72) Inventor: David A. Gelb, West Hartford, CT (US)

(21) Appl. No.: 14/193,823

(22) Filed: Feb. 28, 2014

Related U.S. Application Data
(60) Provisional application No. 61/772,114, filed on Mar. 4, 2013.

(51) Int. Cl. G06F 19/00

(52) U.S. Cl. CPC G06F 19/3487; G06F 19/3418
USPC 705/2

(57) ABSTRACT

Embodiments relate to medical implant management. An aspect includes calculating an efficacy of a medical device based on a plurality of outcomes of medical procedures that utilized the medical device. It is determined that the efficacy of the medical device meets a threshold. Information about the efficacy of the medical device is transmitted to at least one recipient based on the efficacy of the medical device meeting the threshold. The information identifies the medical device.

### CROSS-REFERENCE TO RELATED APPLICATION

This application claims the benefit of U.S. Provisional Application No. 61/772,114, filed Mar. 4, 2013, and entitled “Medical Implant Management”, the content of which is incorporated herein by reference in its entirety.

### BACKGROUND

The present invention relates to medical implants, and more specifically, to managing medical implants.

### SUMMARY

Embodiments include a method, system and computer program product for medical implant management. The method includes calculating an efficacy of a medical device based on a plurality of outcomes of medical procedures that utilized the medical device. It is determined that the efficacy of the medical device meets a threshold. Information about the efficacy of the medical device is transmitted to at least one recipient based on the efficacy of the medical device meeting the threshold. The information identifies the medical device.

Embodiments further include a method for medical implant management. The method includes calculating an efficacy of a medical protocol and medical device based on a plurality of outcomes of medical procedures that utilized the medical protocol and the medical device for patients having selected patient characteristics. It is determined that the efficacy meets a threshold. Information about the efficacy is transmitted to at least one recipient based on the efficacy of the medical protocol and the medical device meeting the threshold. The information identifies the medical protocol, the medical device, and the selected patient characteristics.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 illustrates a block diagram of a system for managing medical implants in accordance with an embodiment;

FIG. 2 illustrates an overview of functions performed by the medical implant management system in accordance with an embodiment;

FIG. 3 illustrates a block diagram of a process flow for populating a data warehouse and performing data analytics in accordance with an embodiment;

FIG. 4 illustrates processes and data used during user registration and system configuration of a medical implant management system in accordance with an embodiment;

FIG. 5 illustrates processes and data used during patient registration in accordance with an embodiment;

FIG. 6 illustrates processes and data used to support chain of custody in accordance with an embodiment;

FIG. 7 illustrates processes and data used to support healthcare providers in accordance with an embodiment;

FIG. 8 illustrates a block diagram of data stored by the medical implant management system and consumers of the data in accordance with an embodiment;

FIG. 9 illustrates a block diagram of a system for medical implant management in accordance with an embodiment; and

FIG. 10 illustrates a block diagram of a security configuration that may be implemented in accordance with an embodiment.

### DETAILED DESCRIPTION

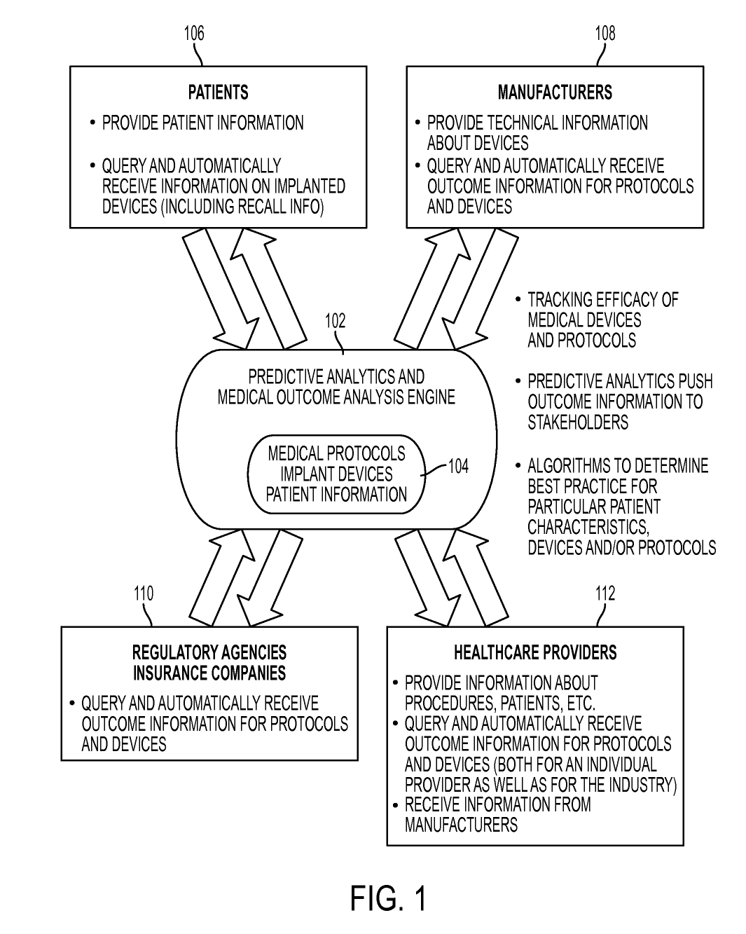

Turning now to FIG. 1, a block diagram of a system for managing medical implants is generally shown. As depicted in FIG. 1, an embodiment of the medical implant management system includes a predictive analytics and medical outcome analysis engine 102 and a data warehouse 104. In an embodiment, the predictive analytics and medical outcome analysis engine 102 is accessed by patients 106, manufacturers 108, regulatory agencies/insurance companies 110, and healthcare providers 112. The predictive analytics and medical outcome engine 102 can also include an interface to the data warehouse 104 that stores data related to medical protocols, implant devices, and patient information. Embodiments of the predictive analytics and medical outcome analysis engine 102 can be used to track the efficacy of medical devices (e.g., implant devices) and protocols (e.g., medical protocols); to perform predictive analytics and push outcome information to stakeholders (e.g., patients 106, manufacturers 108, regulatory agencies/insurance companies, and/or healthcare providers 112); and to execute algorithms to suggest a best practice for particular patient characteristics, implant devices and/or medical protocols.

As used herein, the term “implant device” refers to a medical device that is manufactured to replace a missing biological structure, to support a damaged biological structure, and/or to enhance an existing biological structure. Examples of implant devices include, but are not limited to: dental implant devices, mesh implant devices and hip implant device. As used herein, the term “particular implant device” is used to refer to a type of implant device (e.g., dental implant device, a hip implant device), a model number of an implant device, and/or a serial number or serial number range of an implant device.

As used herein, the term “medical protocol” refers to a series of steps or guidelines followed by a healthcare provider in a medical setting to treat a patient (i.e., to perform a medical procedure). Medical protocols are associated with particular medical conditions and often vary among different health care providers.

As shown in FIG. 1, patients 106 may provide patient information for storage in the data warehouse 104 via an input interface provided, for example, by the predictive analytics and medical outcome analysis engine 102. As used herein, the term “patient” refers to an individual who is receiving medical treatment. In an embodiment, the input interface (e.g., a user interface screen) may include security controls so that each patient can enter only their own patient information and/or patient information for other patients who have given them authorization to enter patient information.

In addition to entering patient information into the data warehouse 104, patients 106 may query and automatically receive information about implant devices from the data warehouse 104. In an embodiment, a patient may query the data warehouse 104 for information about particular implant devices, such as an implant device that has been placed in the patient by a healthcare provider. In an embodiment, the predictive analytics and medical outcome analysis engine 102 provides a query interface to patients 106. The query interface may include security controls so that only particular patients 106 can view particular data content in the data warehouse 104. For example, a patient may be restricted to information about particular implant devices (e.g., implant devices located in the patient) and particular information about the implant devices (e.g., information that the manufacturer has authorized for release to a patient).

The predictive analytics and medical outcome analysis engine 102 may also push information (i.e., the recipient automatically receives the information) based on data stored in the data warehouse 104 about a particular implant device to patients that have an interest in the particular implant device. The predictive analytics and outcome analysis engine 102 may execute algorithms (e.g., queries) to analyze the data in the data warehouse 104 and then selectively push the results of the analysis to particular patients 106. In an embodiment, the algorithms are created and/or customized by one of the stakeholders and/or by the provider of the medical implant management system. For example, the predictive analytics and medical outcome analysis engine 102 may be used to push recall information to affected patients 106 (e.g., those who have the recalled implant device in their body). Depending on the type of implant and the granularity of the data stored in the data warehouse 104 this could include every patient having a particular implant device (e.g., identified by a mode number or type), every patient having a particular implant device within a serial number range, or a particular patient having a specific implant device (e.g., identified by a specific serial number). In another example, the predictive analytics and medical outcome analysis engine 102 may be used to push information (e.g., outcome, follow up care instructions) to a particular patient based on at least one of a particular medical protocol, implant device, and/or patient characteristic being associated with the particular patient.

Also as shown in FIG. 1, manufacturers 108 may provide technical information about implant devices for storage in the data warehouse 104 via an input interface provided, for example, by the predictive analytics and medical outcome analysis engine 102. As used herein, the term “manufacturer” refers to an entity that creates or sells an implant device. In an embodiment, the input interface may include security controls so that each manufacturer can enter only information about their own products. In addition to entering technical information about implant devices into the data warehouse 104, manufacturers 108 may query and automatically receive information about implant devices from the data warehouse 104. In an embodiment, a manufacturer may query the data warehouse 104 for information about outcomes associated with particular implant devices or particular implant device/protocol combinations for implant devices, for example, that have been manufactured or sold by the manufacturer. In an embodiment, the predictive analytics and medical outcome analysis engine 102 provides a query interface to manufacturers 108. The query interface may include security controls so that only particular manufacturers 108 can view particular data content in the data warehouse 104. For example, a manufacturer may be restricted to outcome information about particular implant devices (e.g., implant devices manufactured by the manufacturer) and particular information about the outcome or medical protocols (e.g., information that the patient or health care provider has authorized for release to the manufacturer).

The predictive analytics and medical outcome analysis engine 102 may also push information (i.e., the manufacturer automatically receives the information) based on data stored in the data warehouse 104 about outcomes associated with particular implant devices or particular implant device/medical protocol combinations or particular implant device/medical protocol/patient characteristics combination or other data combination. The predictive analytics and outcome analysis engine 102 may execute algorithms (e.g., queries) to analyze the data in the data warehouse 104 and then selectively push the results of the analysis to particular manufacturers 108. In an embodiment, the algorithms are created and/or customized by one of the stakeholders and/or by the provider of the medical implant management system. For example, the predictive analytics and medical outcome analysis engine 102 may be used to push outcome information to a manufacturer of a particular implant device when it is used in combination with a particular medical protocol on a patient with particular characteristics. This outcome data may be used by manufacturers 108 to improve the implant devices and/or to improve instructions about recommended uses of the implant devices.

Also as shown in FIG. 1, regulatory agencies/insurance companies 110 may query and automatically receive outcome information about implant devices and medical protocols from the data warehouse 104. As used herein, the term “regulatory agency” refers to a governmental or private organization that sets guidelines, monitors, controls and/or gives rulings associated with medical implant devices. In an embodiment, a regulatory agency and/or an insurance company may query the data warehouse 104 for information about outcomes associated with particular implant devices or particular implant device/protocol combinations for implant devices, for example, that have been performed by particular healthcare providers 112 or at particular locations (e.g., hospital, office). In an embodiment, the predictive analytics and medical outcome analysis engine 102 provides a query interface to regulatory agencies/insurance companies 110. The query interface may include security controls. In an embodiment, the regulatory agencies/insurance companies 110 also provide information to the data warehouse 104 related, for example, to insurance coverage of particular implant device, medical protocol and/or patient combinations.

The predictive analytics and medical outcome analysis engine 102 may also push information (i.e., the regulatory agency/insurance company automatically receives the information) based on data stored in the data warehouse 104 about outcomes associated with particular implant devices or particular implant device/medical protocol combinations or particular implant device/medical protocol/patient characteristics combination or other data combination. The predictive analytics and outcome analysis engine 102 may execute algorithms (e.g., queries) to analyze the data in the data warehouse 104 and then selectively push the results of the analysis to particular regulatory agencies/insurance companies 110. In an embodiment, the algorithms are created and/or customized by one of the stakeholders and/or by the provider of the medical implant management system. This output of the algorithms may be used by regulatory agencies/insurance companies 110, for example, to view trends, to make patient care recommendations or to determine insurance coverage amounts.

Also as shown in FIG. 1, healthcare providers 112 may provide information about medical protocols (or procedures), patient characteristics and outcomes for storage in the data warehouse 104 via an input interface provided, for example, by the predictive analytics and medical outcome analysis engine 102. As used herein, the term “healthcare provider” refers to an individual (e.g., doctor, nurse) or a group of individuals (e.g., a practice group). The term “healthcare provider” is also used to refer to a medical care facility (e.g., a hospital, a rehabilitation center) or a group of medical care facilities. In an embodiment, the input interface may include security controls so that each healthcare provider can enter only information about their own patients and/or medical protocols. In addition to entering information about medical protocols, patients and outcomes into the data warehouse 104, healthcare providers 112 may query and automatically receive outcome information for medical protocols and implant devices (e.g., for an individual healthcare provider, for the healthcare industry) from the data warehouse 104. In an embodiment, a healthcare provider may query the data warehouse 104 for information about outcomes associated with particular implant devices or particular implant device/medical protocol combinations or particular implant device/medical protocol/patient characteristic combinations or other data combinations. In addition, a healthcare provider may query the data warehouse 104 to determine whether a particular procedure and/or medical implant is covered by insurance. In an embodiment, the predictive analytics and medical outcome analysis engine 102 provides a query interface to healthcare providers 112. The query interface may include security controls so that only particular healthcare providers 112 can view particular data content in the data warehouse 104. For example, a healthcare provider may be restricted to information (e.g., outcome data) about particular implant devices and medical protocols. In addition, a healthcare provider may be restricted to outcome data related to procedures performed by specified healthcare providers (e.g., the individual healthcare provider, a practice group of healthcare providers, healthcare providers identified as having a particular specialty). In another example, the healthcare provider may be able to view all outcome data for particular patients (e.g., the healthcare provider's patients) and summary information that masks patient identify for other patients.

The predictive analytics and medical outcome analysis engine 102 may also push information (i.e., the healthcare provider automatically receives the information) based on data stored in the data warehouse 104 about outcomes associated with particular implant devices or particular implant device/medical protocol combinations or particular implant device/medical protocol/patient characteristics combination or other data combination. The predictive analytics and medical outcome analysis engine 102 may also provide summary information about the efficacy of particular medical implants (including, for example, data about medical protocols and patient characteristics) that the data warehouse 104 indicates that the healthcare provider is using. The predictive analytics and outcome analysis engine 102 may execute algorithms (e.g., queries) to analyze the data in the data warehouse 104 and then selectively push the results of the analysis to particular healthcare providers 112. In an embodiment, the algorithms are created and/or customized by one of the stakeholders and/or by the provider of the medical implant management system. For example, the predictive analytics and medical outcome analysis engine 102 may be used to push outcome information to a healthcare provider of a particular patient or group of patients with particular characteristics. In addition, healthcare providers 112 may receive medical implant device recall information or suggested process information or other information from manufacturers 108.

A process performed by an embodiment of the medical implant management application can include calculating an efficacy of a medical device based on a plurality of outcomes of medical procedures that were performed using the medical device. As used herein, the term “efficacy” is used to refer to the ability to produce a desired effect. Thus, the efficacy of a medical device refers to the capacity for beneficial change (or therapeutic effect) when a given medical device is utilized. The calculated efficacy is compared to a threshold to determine whether the efficacy of the medical device meets the threshold. The threshold can be programmable and can vary based on criteria such as, but not limited to: the intended recipient of the information, characteristics of the medical device (e.g., type, model, serial number), characteristics of the patient, characteristics of the protocol, and/or other data stored in the data warehouse or entered by a user. Meeting the threshold can indicate, for example, that a calculated efficacy is below a particular number, above a particular number or within one or more specified ranges. Information about the efficacy of the medical device is transmitted to at least one recipient based on the efficacy of the medical device meeting the threshold. The information identifies the medical device.

In other embodiments one or more medical protocols and/or patient characteristics are input to the efficacy calculation. Efficacy calculations may be based on data stored, for example, in the data warehouse 104. Examples include, but are not limited to: calculating the efficacy based on of a combination of a particular medical device and medical protocol combination; or based on a combination of a particular medical device and particular patient characteristics. Any number of data combinations may be utilized.

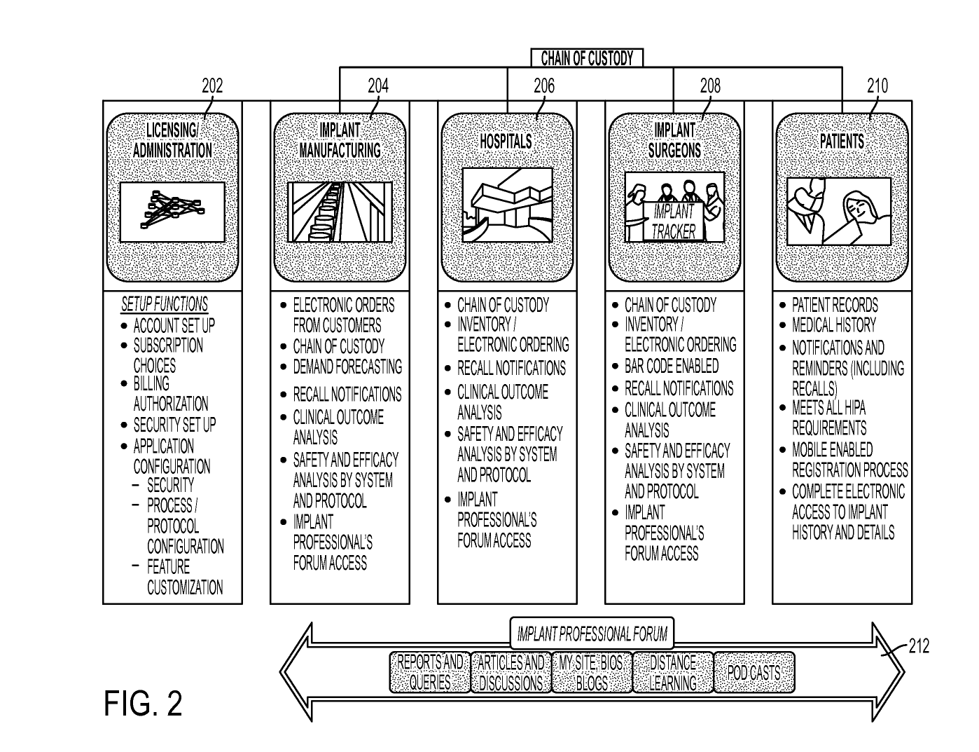

Turning now to FIG. 2, an overview of functions performed by an embodiment of the medical implant management system is generally shown. The functions shown in FIG. 2 include licensing/administration functions 202, implant manufacturing functions 204, hospital functions 206, implant surgeon functions 208 and patient functions 210. In an embodiment, the data used by the functions shown in FIG. 2 is stored in the data warehouse 104. The medical implant management system may also support chain of custody tracking of an implant device starting with manufacturers 108 then to healthcare providers 112 (hospitals, implant surgeons) and finally to patients 104. Also shown in FIG. 2 is an implant professional's forum interface 212 that may include access to information in the data warehouse 104 (or in other locations) to support information sharing amount healthcare providers 112. The implant professional's forum interface 212 may be accessible via the medical implant management system.

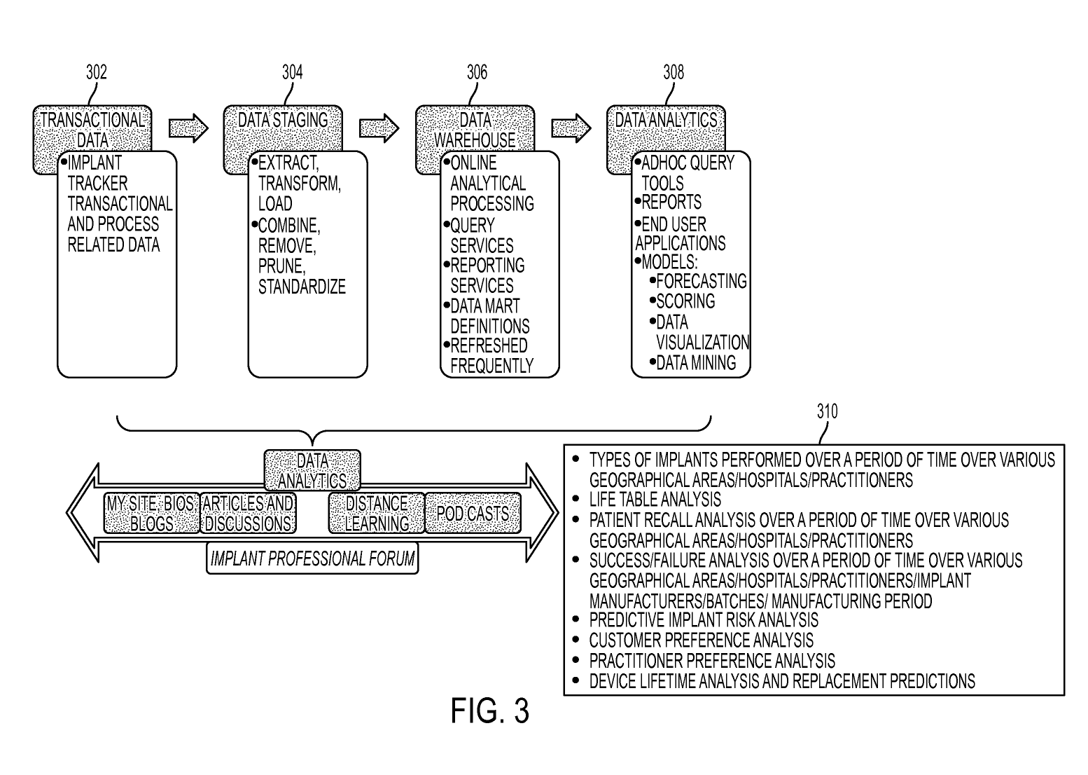

Turning now to FIG. 3, a block diagram of a process flow for populating the data warehouse 104 and performing data analytics is generally shown. At block 302 transactional data related to patients having implant procedures is generated. In an embodiment, the transactional data is imported from a transactional system used by a healthcare provider to manage a medical practice. At block 304, data staging is performed to convert the transactional data for storage in the data warehouse 104. The data staging at block 304 may include extracting the transactional data, transforming the transactional data into a format compatible with the data warehouse 104, and loading the transformed data into the data warehouse 104. As shown in FIG. 3, the data staging at block 304 may also include combining data, removing data, pruning data, and standardizing data. Block 304 may be performed on periodic basis and/or in response to specified events (e.g., a specified level of activity in the transactional system). At block 306 data warehousing functions are provided, including, but are not limited to: online analytical processing, query services, reporting services, data mart definitions, and refresh services. At block 308, data analytics functions are provided, including, but not limited to: adhoc query tools, report tools, end user applications, model (e.g., forecasting, scoring, data visualization, and data mining). In an embodiment, the data analytics functions are provided via the predictive analytics and medical outcome analysis engine 102.

As shown in FIG. 3, various types of analytics 312 may be performed by healthcare providers 112 using an implant professional forum interface 310. The example analytics 312 shown in FIG. 3 are intended to be exemplary in nature and not limiting.

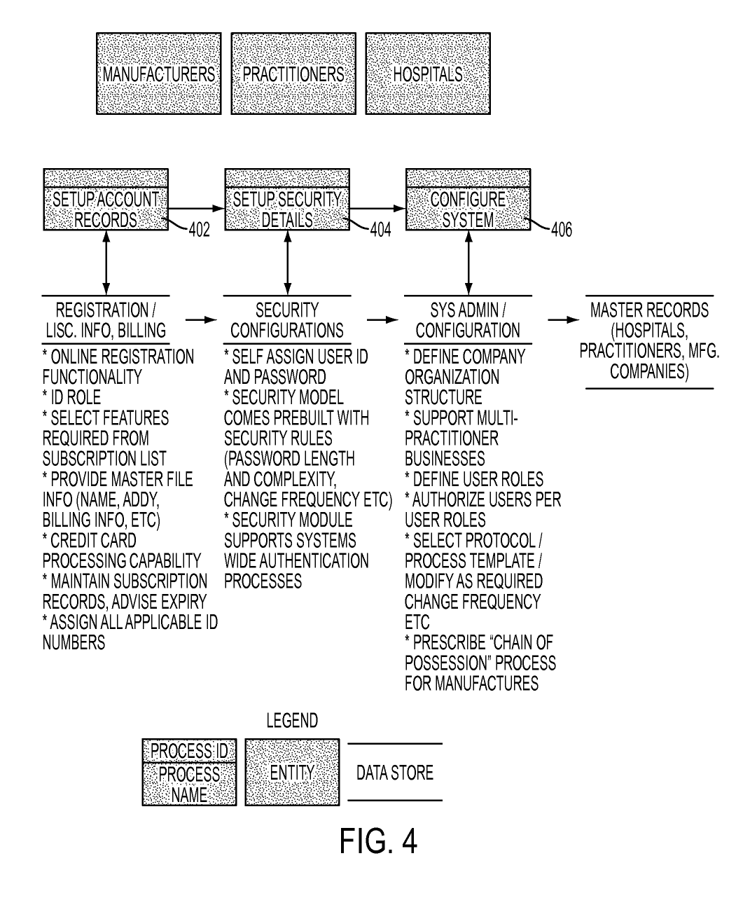

FIG. 4 illustrates processes and data used during user registration and system configuration of a medical implant management system in accordance with an embodiment. In the embodiment shown in FIG. 4, the users of the system include manufacturers, medical practitioners and hospitals. At block 402, account records that include registration, licensing information, and billing information are setup for users of the system. At block 404, security configurations are setup, and at block 406, the system is configured to generate system administration and configuration records. The result of the process in FIG. 4 includes master records that are used to control access to functions and data in the medical implant management system. The master records may be stored in the data warehouse 104. The processing described in FIG. 4 may be performed using a variety of user interfaces and algorithms provided, for example, by the predictive analytics and medical outcome analysis engine 102.

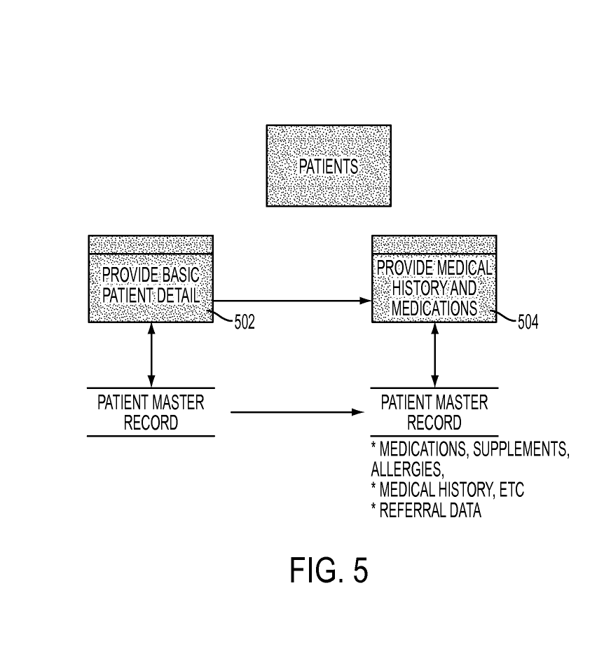

FIG. 5 illustrates processes and data used during patient registration in accordance with an embodiment. At block 502, a patient (or another party such as a healthcare provider on behalf of the patient) provides basic patient details that may be used to generate a patient master record. At block 504, a patient (or another party such as a healthcare provider on behalf of the patient) provides medical history and medication information which may be used to update the patient master record. The patient master record may be stored in the data warehouse 104. The processing described in FIG. 5 may be performed using a variety of user interfaces and algorithms provided, for example, by the predictive analytics and medical outcome analysis engine 102.

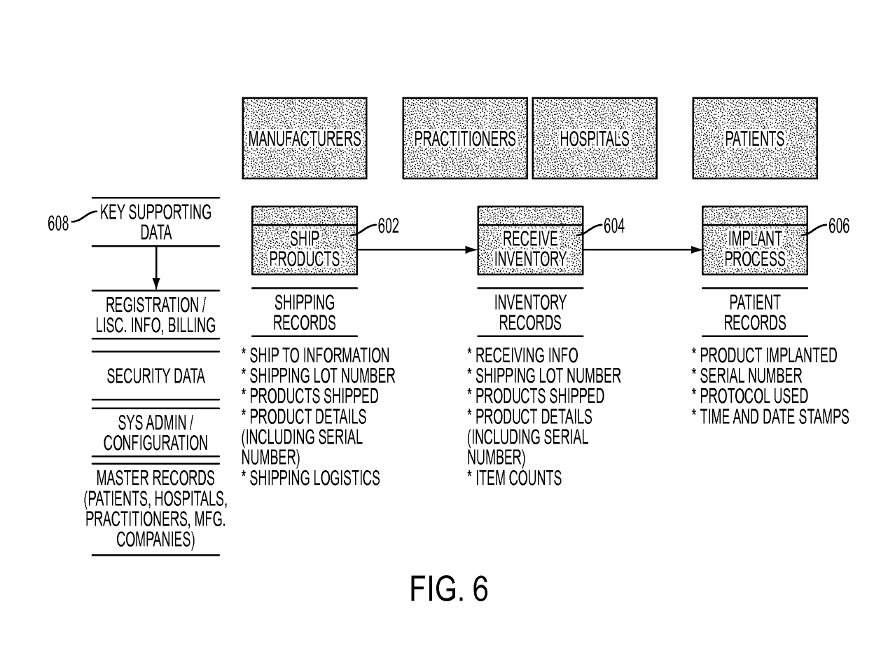

FIG. 6 illustrates processes and data used to support chain of custody in accordance with an embodiment. Input data 608 may include registration information, licensing information, billing information, security data, system administration and configuration information, and master records for registered users. At block 602, manufacturers 108 ship products (e.g., implant devices) and shipping records are generated. At block 604, healthcare providers 112 (e.g., practitioners and hospitals) receive the inventory and create inventory records. At block 606 implant procedures are performed and a patient record is updated to reflect the product implanted in the patient (e.g., a serial number of the product) along with data such as the protocol used to perform the implant. The shipping records, inventory records, and patient records may be stored in the data warehouse 104. The processing described in FIG. 6 may be performed using a variety of user interfaces and algorithms provided, for example, by the predictive analytics and medical outcome analysis engine 102.

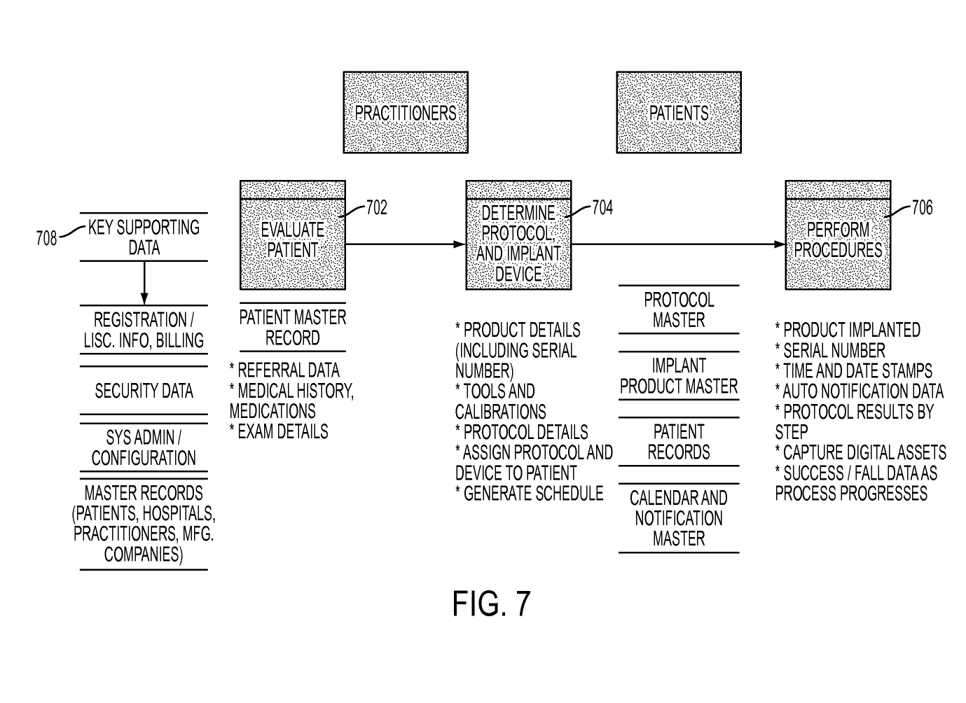

FIG. 7 illustrates processes and data used to support healthcare providers 112 in accordance with an embodiment. Input data 708 may include registration information, licensing information, billing information, security data, system administration and configuration information, and master records for registered users. At block 702, a patient is evaluated, and at block 704 the healthcare provider determines what protocol and implant device to use for the patient. At block 706, the procedure is performed and data related to the procedure is stored. The protocol master records, implant product master records, and calendar and notification master records shown in FIG. 7 may be stored in the data warehouse 104. The processing described in FIG. 7 may be performed using a variety of user interfaces and algorithms provided, for example, by the predictive analytics and medical outcome analysis engine 102.

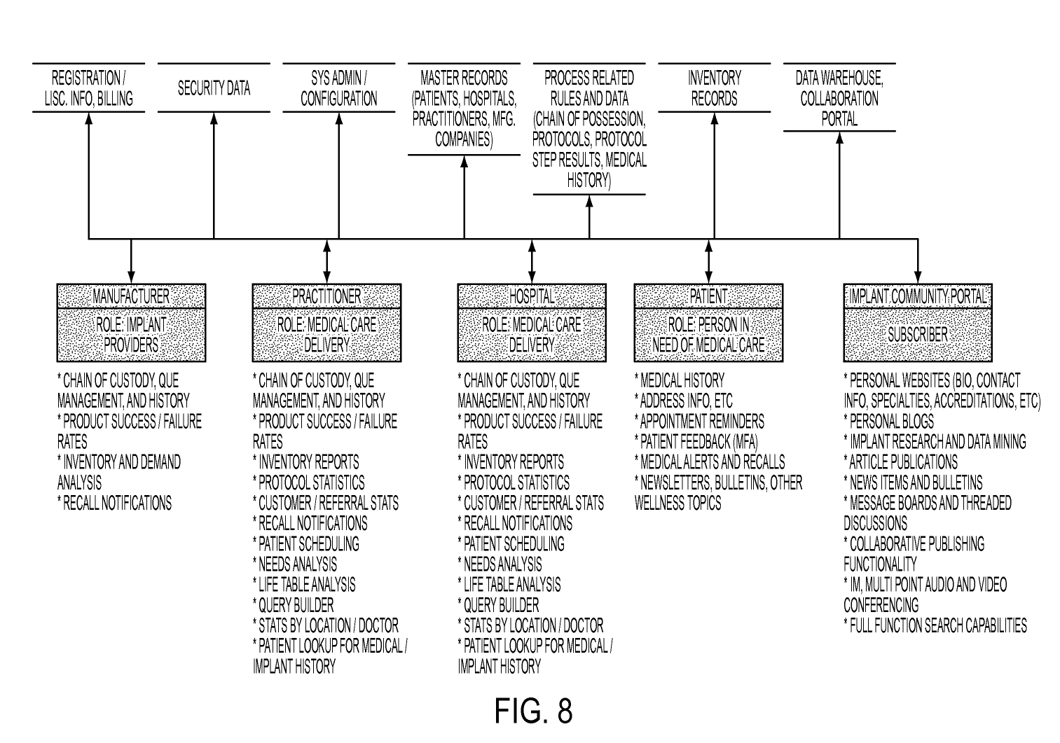

FIG. 8 illustrates a block diagram of data stored by the medical implant management system and consumers of the data in accordance with an embodiment.

A user interface screen related to patient information in accordance with an embodiment when the medical devices are dental implant devices can include fields such as, but not limited to: chart number; last name; first name; sex; medical considerations (e.g., smoker); birthdate; referring dentist; work phone; home phone; cell phone; additional information (e.g., last follow up and other custom fields); and surgeon.

A user interface screen related to a patient treatment plan in accordance with an embodiment when the medical devices are dental implant devices can include fields such as, but not limited to: procedures performed and associated costs.

A user interface screen related to a fixture failure in accordance with an embodiment when the medical devices are dental implant devices can include fields such as, but not limited to: a chart number of a patient; a patient last name and first name; a type of failure (e.g., stage one, stage two, loaded, fracture); a mouth location; an implant replacement status; a site use failure number; a date of failure; fixture warranty information; and optional information such as complications or other customer fields).

Additional user interface screens can be related to patient recalls, patient treatment summaries, data about a medical process (e.g., surgery) performed on a patient, future treatment needs of a patient, referring medical professionals, summary patient profiles, summary success and failure rates, medical device inventory, customizable letters and other custom queries.

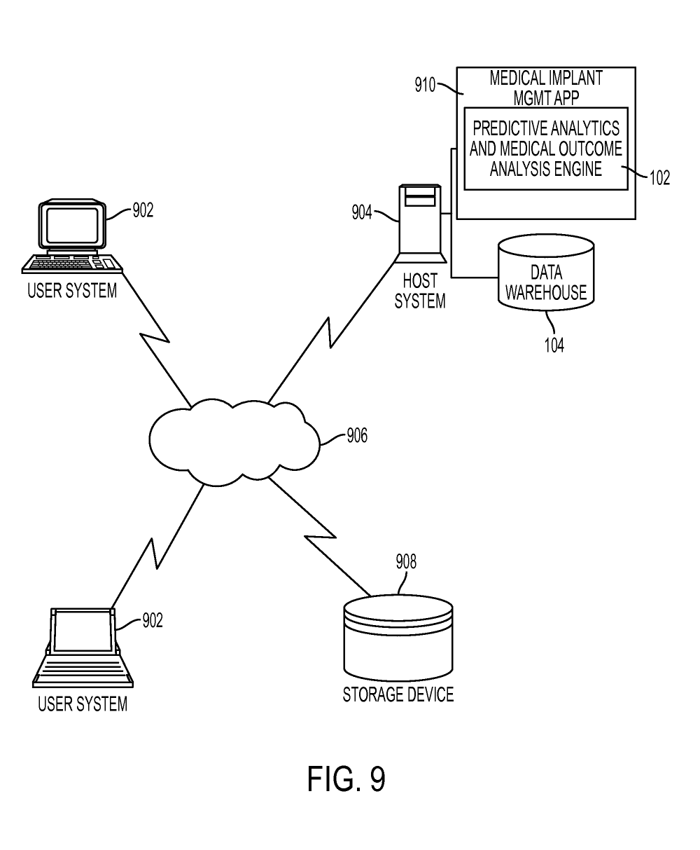

Referring to FIG. 9, a block diagram of an exemplary system for medical implant management is generally shown. The system includes medical implant management application 910 that is executed by one or more computer programs located on a host system 904. The system depicted in FIG. 9 also includes one or more user systems 902 through which users (e.g., healthcare providers 112, manufacturers 108, patients 106, etc.) at one or more geographic locations may contact the host system 904. In an embodiment, users perform the processing described above in FIGS. 1-8 via the user systems 902. The user systems 902 are coupled to the host system 904 via a network 906. Each user system 902 may be implemented using a general-purpose computer executing a computer program for carrying out the processes described herein. The user systems 902 may be personal computers (e.g., a lap top, a tablet computer, a cellular telephone) or host attached terminals. If the user systems 902 are personal computers, the processing described herein may be shared by a user system 902 and the host system 904.

The network 906 may be any type of known network including, but not limited to, a wide area network (WAN), a local area network (LAN), a global network (e.g. Internet), a virtual private network (VPN), and an intranet. The network 906 may be implemented using a wireless network or any kind of physical network implementation known in the art. A user system 902 may be coupled to the host system through multiple networks (e.g., cellular and Internet) so that not all user systems 902 are coupled to the host system 904 through the same network. One or more of the user systems 902 and the host system 904 may be connected to the network 906 in a wireless fashion. In one embodiment, the network is the Internet and one or more user systems 902 execute a user interface application (e.g. a web browser) to contact the host system 904 through the network 906. In another exemplary embodiment, the user system 902 is connected directly (i.e., not through the network 906) to the host system 904. In a further embodiment, the host system 904 is connected directly to or contains the storage device 908. In an embodiment, the user systems 902 have support for user interface screens displayed on display devices that can be used for data input and/or output.

The storage device 908 includes data relating to medical implant management and may be implemented using a variety of devices for storing electronic information. Though shown as a separate from the storage device 908, the data warehouse 104 may be completely or partially contained in the storage device 908. The term storage device 908 when used herein includes the data stored in the data warehouse 104. It is understood that the storage device 908 may be implemented using memory contained in the host system 904 or that it may be a separate physical device. The storage device 908 is logically addressable as a consolidated data source across a distributed environment that includes the network 906. Information stored in the storage device 908 may be retrieved and manipulated via the host system 904 and/or via a user system 902. The data warehouse 104 may be implemented using any technology that supports the processing described herein. For example, the data warehouse 104 may be implemented as a relational database with structured query language (SQL) queries used to access the data.

The host system 904 depicted in FIG. 9 may be implemented using one or more servers operating in response to a computer program stored in a storage medium accessible by the server. The host system 904 may operate as a network server (e.g., a web server) to communicate with the user system 902. The host system 904 handles sending and receiving information to and from the user system 902 and can perform associated tasks. The host system 904 may also include a firewall to prevent unauthorized access to the host system 904 and enforce any limitations on authorized access. For instance, an administrator may have access to the entire system and have authority to modify portions of the system. A firewall may be implemented using conventional hardware and/or software as is known in the art.

The host system 904 may also operate as an application server. The host system 904 executes one or more computer programs, including a medical implant management application 910, to perform the functions described herein. Processing may be shared by the user system 902 and the host system 904 by providing an application to the user system 902. Alternatively, the user system 902 can include a stand-alone software application for performing a portion or all of the processing described herein. As previously described, it is understood that separate servers may be utilized to implement the network server functions and the application server functions. Alternatively, the network server, the firewall, and the application server may be implemented by a single server executing computer programs to perform the requisite functions.

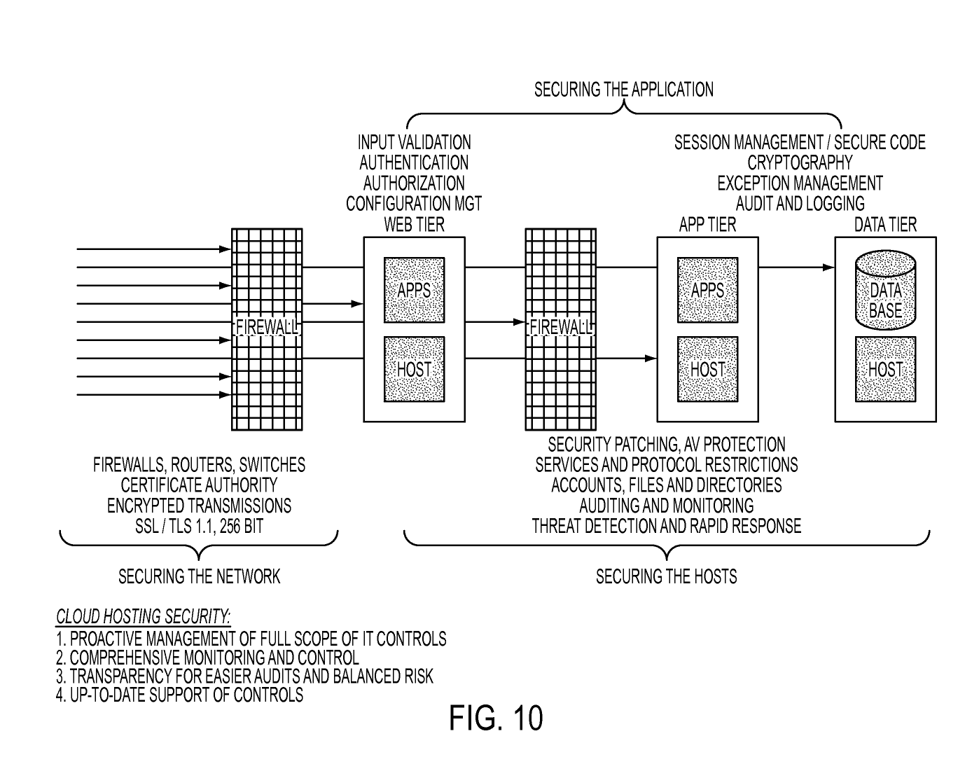

FIG. 10 illustrates a block diagram of a security configuration that may be implemented by an embodiment of the medical implant management system.

Embodiments may utilize a cloud based delivery of the medical implant management application to provide a highly secure, fully resilient system that is deployable globally. The use of cloud based delivery allows for shared infrastructure and support which may reduce system complexity and cost, as well as simplify maintenance and upgrades.

Embodiments may provide the medical implant management application as a service. An embodiment includes on demand subscription based services. This allows the use of a shared code base which reduces complexity and support costs, as well as providing broad access to data and collaboration.

Embodiments may provide browser based access and full mobility support. An embodiment includes thin client access with support for all major browsers. Embodiments support tablet computers and handheld computers (e.g., cell phones). Embodiments may also provide support for scanning.

Embodiments may provide interfaces to existing computer systems to retrieve or provide data. This allows for medical implant management system to operate along with existing systems. Embodiments support the secure exchange of data between systems in accordance with established security protocols and governmental regulations. Data can be exchanged for purposes including, but not limited to: ensuring data integrity, improving healthcare provider efficiency and accuracy, and improving patient care by enhancing availability of patient information.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

What is claimed is:

1. A method for medical implant management, the method comprising:
calculating an efficacy of a medical device based on a plurality of outcomes of medical procedures that utilized the medical device;
determining that the efficacy of the medical device meets a threshold; and
transmitting information about the efficacy of the medical device to at least one recipient based on the efficacy of the medical device meeting the threshold, the information identifying the medical device.

2. The method of claim 1, wherein the method further comprises transmitting information about the medical procedures based on the efficacy of the medical device meeting the threshold.

3. The method of claim 1, wherein the method further comprises transmitting information about the plurality of outcomes based on the efficacy of the medical device meeting the threshold.

4. The method of claim 1, wherein the calculating is further based on characteristics of patients receiving the medical procedures and the information further comprises data that identifies the characteristics of the patients.

5. The method of claim 1, wherein the calculating is further based on at least one medical protocol followed during the medical procedures and the information further comprises data that identifies the medical protocol.

6. The method of claim 1, wherein a plurality of different healthcare providers performed the medical procedures.

7. The method of claim 1, wherein the recipient is at least one of a manufacturer and a healthcare provider.

8. The method of claim 1, wherein the calculating is performed on a periodic basis.

9. The method of claim 1, wherein the plurality of outcomes are stored in a data warehouse.

10. The method of claim 1, wherein the calculating, determining and transmitting are performed by a predictive analytics and medical outcome analysis engine.

11. The method of claim 1, wherein the information identifying the medical device includes at least one of a type of the medical device, a model number of the medical device, a serial number range of the medical device, and a serial number of the medical device.

12. A computer program product for medical implant management, the computer program product comprising:
a tangible storage medium readable by a processing circuit and storing instructions for execution by the processing circuit for performing a method comprising:
calculating an efficacy of a medical device based on a plurality of outcomes of medical procedures that utilized the medical device;
determining that the efficacy of the medical device meets a threshold; and
transmitting information about the efficacy of the medical device to at least one recipient based on the efficacy of the medical device meeting the threshold, the information identifying the medical device.

13. The computer program product of claim 12, wherein the method further comprises transmitting, based on the efficacy of the medical device meeting the threshold, at least one of information about the medical procedures, and information about the plurality of outcomes.

14. The computer program product of claim 12, wherein the calculating is further based on characteristics of patients receiving the medical procedures and the information further comprises data that identifies the characteristics of the patients.

15. The computer program product of claim 12, wherein the calculating is further based on at least one medical protocol followed during the medical procedures and the information further comprises data that identifies the medical protocol.

16. The computer program product of claim 12, wherein the recipient is at least one of a manufacturer and a healthcare provider.

17. A computer system for medical implant management, the system comprising:
a memory having computer readable instructions; and
a processor for executing the computer readable instructions, the instructions including:
calculating an efficacy of a medical device based on a plurality of outcomes of medical procedures that utilized the medical device;
determining that the efficacy of the medical device meets a threshold; and
transmitting information about the efficacy of the medical device to at least one recipient based on the efficacy of the medical device meeting the threshold, the information identifying the medical device.

18. A method for medical implant management, the method comprising:
calculating an efficacy of a medical protocol and a medical device based on a plurality of outcomes of medical procedures that utilized the medical protocol and medical device for patients having selected patient characteristics;
determining that the efficacy meets a threshold; and
transmitting information about the efficacy to at least one recipient based on the efficacy meeting the threshold, the information identifying the medical protocol and the medical device and the selected patient characteristics.

19. The method of claim 18, wherein the method further comprises transmitting information about the medical procedures based on the efficacy of the medical device meeting the threshold.

20. The method of claim 18, wherein the method further comprises transmitting information about the plurality of outcomes based on the efficacy of the medical device meeting the threshold.
